(19) United States
(12) Patent Application Publication
(10) Pub. No.: US 2013/0266287 A1
(43) Pub. Date: Oct. 10, 2013

(54) REPRODUCTION DEVICE AND REPRODUCTION METHOD

(71) Applicants: Hidenori Sakaniwa, Yokohama (JP); Nobuaki Kabuto, Kunitachi (JP); Masahiro Ogino, Ebina (JP)

(72) Inventors: Hidenori Sakaniwa, Yokohama (JP); Nobuaki Kabuto, Kunitachi (JP); Masahiro Ogino, Ebina (JP)

(73) Assignee: HITACHI CONSUMER ELECTRONICS CO., LTD., Tokyo (JP)

(21) Appl. No.: 13/877,300

(22) PCT Filed: Sep. 26, 2011
(86) PCT No.: PCT/JP2011/005357

§ 371 Date: Jun. 24, 2013

(30) Foreign Application Priority Data
Oct. 20, 2010 (JP) 2010-235065

(51) Int. Cl. H04N 13/00

(52) U.S. Cl. CPC H04N 13/0055
USPC 386/230

(57) ABSTRACT

When a reproduction device and a display device are separated, there is the risk that it will not be possible to appropriately overly menu images or the like on a 3D video signal in the reproduction device. This reproduction method, which outputs a video signal generated in a reproduction device to a display device, has: a step for reproducing a video signal; a step for generating image information to be superimposed on the reproduced video signal; a step for superimposing the generated image information on the reproduced video signal; a step for outputting the video signal to which the image information has been superimposed; a step for reading information relating to the display device from the display device; and a step for acquiring information relating to the state of the display device from the display device. The configuration is such that the method of superimposing the image information on the video signal is altered on the basis of the acquired information relating to the state of the display device and the read information relating to the display device.

### TECHNICAL FIELD

The technical field relates to the transmission and reception of video signals.

### BACKGROUND ART

A video reproduction device; which reproduces broadcast programs saved in a hard disk drive (HDD), or a video reproduction device such as a video player, which reproduces content recorded on a disc, displays a menu as follows. For example, the video reproduction device creates a menu image by creating a video signal embedded in a video being reproduced and, via an interface such as HDMI (abbreviation for High Definition Multimedia Interface, HDMI is a registered trademark of HDMI, LLC), transmits the created menu image to the display device for displaying it thereon.

Patent Literature 1 describes, in Problem to be Solved, that “To provide a three-dimensional information output device and a three-dimensional information output method capable of three-dimensionally displaying flat display information properly” (see Patent Literature 1 [0006]) and in Solution, that “The three-dimensional information output device includes a detection means for detecting a degree of three dimension of a three-dimensional video, a generation means for generating three-dimensional display information from display information based on the degree of three-dimension, and an output means for outputting the three-dimensional display information.” (see Patent Literature 1[0007]).

### CITATION LIST

### Patent Literature

PATENT LITERATURE 1: JP-A-2010-130495

### SUMMARY OF INVENTION

### Technical Problem

Patent Literature 1 describes a technology for a digital tuner, which receives broadcast waves and reproduces them, and a digital television, which includes a video display liquid crystal panel, but not a technology for the case in which the reproduction device and the display device are separated. Therefore, when the reproduction device and the display device are separated, a menu image may not be overlaid properly on a 3D video signal on the reproduction device.

### Solution to Problem

To solve the above problem, the configuration described in Claims is used.

The present invention includes a plurality of means for solving the problem described above. One of the means is a reproduction method that outputs a video signal, reproduced by a reproduction device, to a display device, the reproduction method comprising the steps of reproducing a video signal; generating image information to be superimposed on the reproduced video signal, superimposing the generated image information on the reproduced video signal; outputting the video signal on which the image information is superimposed; reading information about the display device from the display device; and acquiring information about a state of the display device from the display device wherein a method for superimposing the image information on the video signal is changed based on the information about the display device that is read and on the information about the state of the display device that is acquired.

### Advantageous Effects of Invention

The means described above allows two-dimensional display information to be displayed in the three-dimensional format properly even when the reproduction device and the display device are separated, thus increasing user convenience.

### BRIEF DESCRIPTION OF DRAWINGS

FIG. 1 is a block diagram showing an example of the configuration of a video reproduction device and a display device.

FIG. 2 is a diagram showing an example of a problem that is generated between the video reproduction device and the display device.

FIG. 3 is a diagram showing an example of cooperation between the video reproduction device and the display device.

FIG. 4 is a diagram showing an example of video format detection processing in the video reproduction device.

FIG. 5 is a diagram showing an example of video output from the video reproduction device.

FIG. 6 is a diagram showing an example of video output from the video reproduction device.

FIG. 7 is a diagram showing an example of video output from the video reproduction device.

FIG. 8 is a diagram showing an example of video output from the video reproduction device.

FIG. 9 is a diagram showing an example of control messages used for the cooperation between the video reproduction device and the display device.

### DESCRIPTION OF EMBODIMENTS

An embodiment of the present invention is described below with reference to the drawings. In the description of the embodiment, 3D means three dimensions and 2D means two dimensions. For example, a 3D video means a video, which is generated by presenting parallax videos to the right and left eyes, enables an observer to perceive an object three-dimensionally as if the object was in the same space in which the observer is present. A 3D display device is a display device capable of displaying a 3D image. 3D content is content that includes a video signal with which a 3D display device can display a 3D video.

When a reproduction device and a display device are separated and content reproduced on the reproduction device is changed from a 2D video to a Side-by-Side (hereinafter called “SBS”) format 3D video, the user is required to recognize the SBS format 3D video and switch the display device setting to the setting for displaying 3D images (hereinafter also called “3D setting”).

However, the reproduction device cannot recognize that the display device has been switched to the 3D setting. Because of this, when a menu screen that is a 2D video is displayed, there is a possibility that the menu screen is forced to be displayed as an SBS format 3D video with the result that the menu is be cut in half and is displayed in full screen mode. The menu screen, when displayed in this manner, makes it difficult for the user to recognize the menu display.

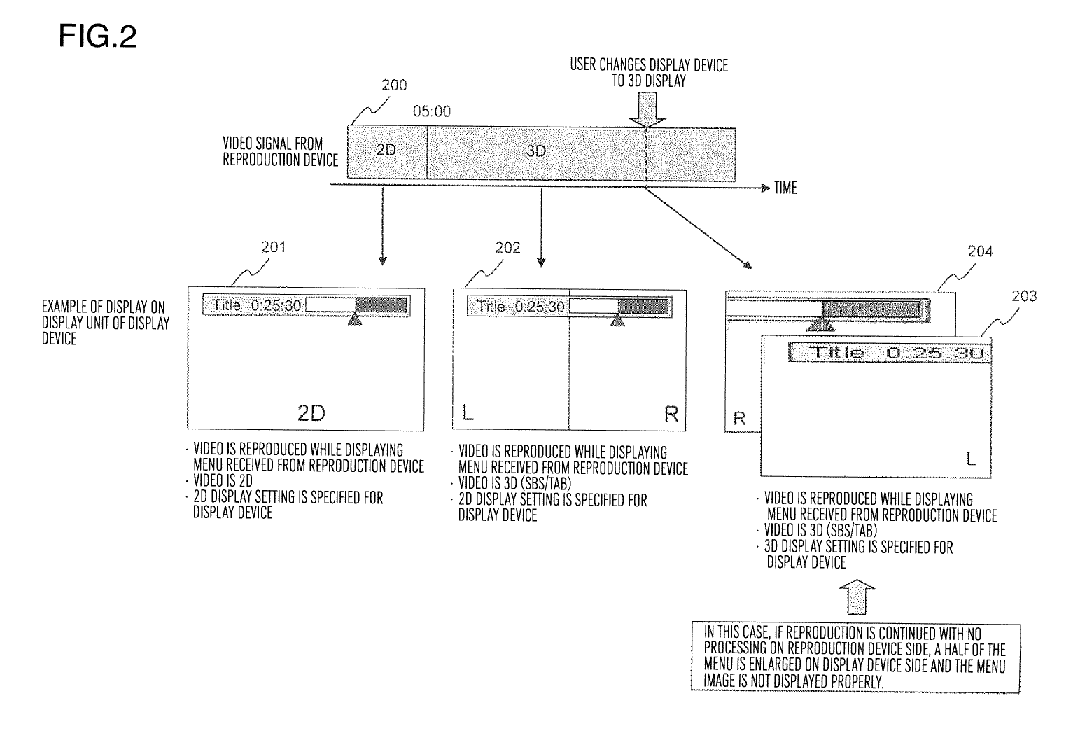

FIG. 2 is a diagram showing the problem with the menu display when an SBS format 3D video is output by the reproduction device.

In FIG. 2, the numeral 200 indicates a video signal generated by a video signal generation unit 102 from input content and is output by the reproduction device. The horizontal axis indicates the time. First, a 2D video signal is generated and, after 05:00 has elapsed after the start of the reproduction video signal, a 3D video signal is generated.

The numerals 201 to 204 are examples showing how the video, output by a video reproduction device 100, is displayed on the display unit of the display device. The numerals 201 to 204 are the cases in which the user views the reproduced video signal 200 while displaying a menu such as the title of reproduced content and the reproduction time display.

The numeral 201 indicates the state in which the user views a 2D video on the display device for which the 2D display setting is specified. In this state, the menu is displayed without any problem.

The numeral 202 indicates the state in which the user views an SBS format 3D video on the display device for which the 2D display setting is specified. The left-eye video (L video) is displayed in the left half, and the right-eye video (R video) in the right half.

The numerals 203 and 204 indicate the state in which the user views an SBS format 3D video on the display device for which the 3D video display setting is specified. When the user switches the display device to the 3D display setting at some point in time, each of the L video and the R video is enlarged into one screen display.

The L video and the R video are displayed on the 3D display device for viewing by the user's left eye and right eye respectively. In this case, if it is not detected by the reproduction device that the display device is switched to the 3D display setting, the reproduction device outputs the same video signal as that in 202 to the display device and, therefore, the menu screen of the reproduction device is cut in half and enlarged on the display device.

Because the L video and the R video enter the left eye and the right eye respectively, the problem is that the menu part is not displayed as a fusion image.

To solve this problem, the embodiment below describes a method for increasing the visibility of an On-Screen Display (OSD) display, such as a menu, and improving user convenience when the display device is switched from a 2D video to a 3D video.

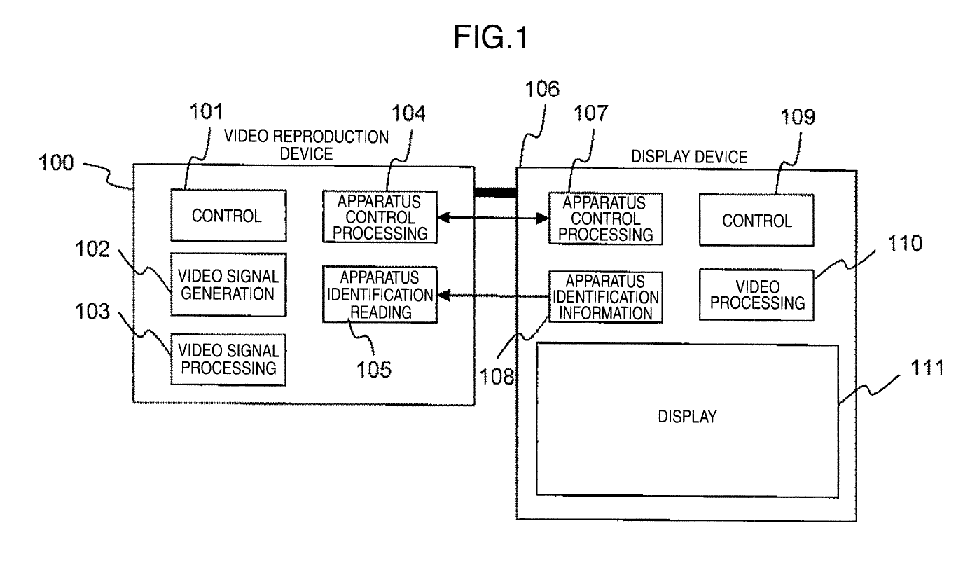

The following describes a first embodiment of the present invention with reference to FIG. 1 and FIGS. 3-9.

FIG. 1 is a block diagram showing an example of the configuration of a video reproduction device and a display device in this embodiment.

Referring to FIG. 1, the numeral 100 indicates a video reproduction device that outputs a 2D video and a 3D Video on the display device. The numeral 101 indicates a control unit that controls video reproduction, menu display, and connected apparatuses. The numeral 102 indicates a video signal generation unit that reproduces 2D content or 3D input content such as broadcast content received via a tuner, content recorded on an internal or external recording medium (hard disk, optical disc, etc) of the reproduction device 100, or content received via a network. The video signal generation unit 102 also generates the image of additional information such as a menu created by an internal program. The video signal generation unit may also be configured to include a reproduction unit that reproduces received content and an image generation unit that generates the image of additional information such as a menu.

The additional information includes a menu display, a caption display, a reproduction state/operation display (play, pause, fast forward, record, double speed, mute, video off, etc.), a PinP (Picture in Picture) display, a reproduction position display (reproduction time, remaining reproduction time, chapter position), volume/channel/input switching/time information, content information (title, broadcast station, date/time, broadcast time, recording quality), reproduction medium information (HDD, BD, DVD), a desktop widget (clock, calendar, news, currency exchange, weather), and an OSD display.

The control unit 101 identifies the data structure defined according to a standard such as MPEG or H.264 and includes a mechanism for determining whether received content is 2D or 3D. 3D content is configured by using 2D video format directly and arranging the left eye (L) video and the right eye video side-by-side in one screen in the Side-By-Side (SBS) format or arranging videos in the top and the bottom in the Top-AND-Bottom (TAB) format. There is also 3D content configured by a plurality of video streams, one video stream for the left-eye and the other video stream for the right-eye.

The numeral 103 indicates a video signal processing unit that, under control of the control unit 101, adjusts the image quality of the video signals generated by the video signal generation unit 102, creates a menu image, performs overlay processing (also called superimposing processing or multiplexing processing) for combining a menu image and a reproduced image, and creates a video signal to be output. The video signal processing unit 103 can perform video processing using a line memory or a frame memory.

The numeral 104 indicates an apparatus control processing unit that controls the cooperation among the connected apparatuses. For example, via an HDMI cable, the apparatus control processing unit 104 performs processing corresponding to the processing of HDMI-CEC (Consumer Electronics Control) that transmits an apparatus status and a control signal to the connected apparatuses for use in the cooperation among the apparatuses. The numeral 105 indicates a processing unit that reads apparatus identification information (for example, EDID (Extended Display Identification Data) information) such as the performance of the connected display device.

The numeral 106 indicates a displaying apparatus such as a display device. When an SBS or TAB format 3D content is displayed in the 3D mode, the display device 106 decompresses the horizontally or vertically compressed image to the size of one screen, creates the left eye (L) video and the right eye (R) video, and transmits the created videos to the left eye and the right eye respectively for displaying the 3D video as a fusion image.

The methods for displaying a 3D video on the display device include the anaglyph 3D method, polarized display method, frame sequential method, parallax barrier method, lenticular lens method, micro-lens array method, and light field display method.

The anaglyph 3D method refers to a method in which videos, shot from different angles in the left and right, are reproduced by overlaying red light and blue light on the videos respectively and viewed through glasses (hereinafter called anaglyph glasses) with red and blue color filters, one for each eye.

The polarized display method refers to a method in which the left video and right videos are projected through linearly polarized light and the videos are separated through eyeglasses that contain a pair of polarizing filters (hereinafter called polarized glasses).

The frame sequential method refers to a method in which videos, shot from different angles in the left and right, are reproduced alternately and viewed through glasses with shutters that alternately block the left and right fields of view (The glasses, which need not have the shape of glasses, refer to a device capable of controlling light transmission through the elements in the lens based on electrical characteristics; hereinafter, the glasses are called “shutter glasses”).

The parallax barrier method refers to a method in which right-eye videos are sent to the right eye and the left-eye videos are sent to the left eye by placing vertically striped barriers, called parallax barriers, in the display. The user need not wear special classes. The parallax barrier method may be further classified into two two-view method for relatively narrower viewing positions and multi-view method for relatively wider viewing positions.

The lenticular lens method refers to a method in which right-eye videos are sent to the right eye and the left-eye videos are sent to the left eye by placing lenticular lenses in the display. The user need not wear special classes. The lenticular lens method may be further classified into two two-view method for relatively narrower viewing positions and multi-view method for relatively wider horizontal viewing positions.

The micro-lens array method refers to a method in which right-eye videos are sent to the right eye and the left-eye videos are sent to the left eye by placing micro-lens arrays in the display. The user need not wear special classes. The micro-lens array method is a multi-view method for relatively wider vertical and horizontal viewing positions.

The light field display method refers to a method in which parallax images are presented to the viewer by reproducing the wave front of light. The user need not wear special classes. The viewing positions are relatively wider.

The 3D video display methods described above are exemplary only and a method other than those described above may be used. The tools or devices required for viewing 3D videos, such as anaglyph glasses, polarized glasses, and shutter glasses, are generically called 3D glasses or 3D viewing aids.

The numeral 107 indicates an apparatus control processing unit that controls the cooperation among connected apparatuses. The numeral 108 indicates an apparatus identification information unit that notifies a connected apparatus about apparatus identification information such as the performance of the display device.

The numeral 109 indicates a control unit of the display control 106. The numeral 110 indicates video processing that processes video signals transmitted from the video reproduction device 100 and performs video processing, such as predetermined scaling processing or image improvement signal processing, according to the display unit. A display unit 111 has the function to display a video for which the video processing 110 has been performed.

The video reproduction device 100 and the display device 105 may be connected with a cable or wirelessly.

Each of the reproduction device and the display device, though described to have a plurality of blocks in FIG. 1 for the sake of description, need not always have a plurality of blocks. The function described for each block may be configured in such a way that the function is processed by one or more CPUs.

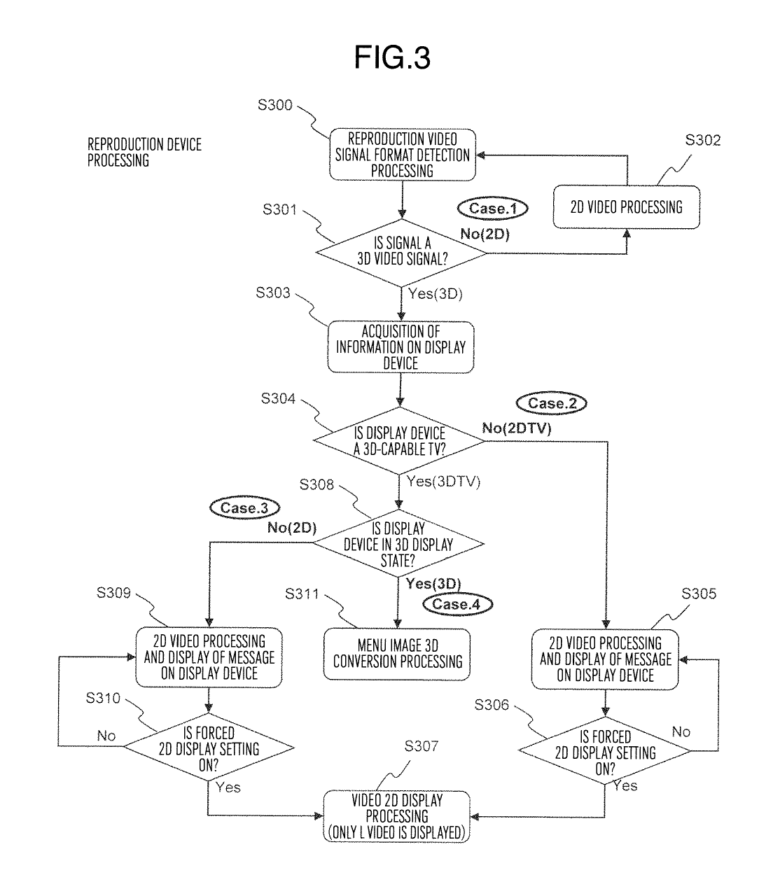

Next, with reference to FIG. 3, the following describes an example of cooperation between the video reproduction device and the display device in this embodiment. In S300, the video signal generation unit 102 detects whether the received content is in the 2D video signal format or the 3D video signal format. Whether the signal is a 2D video signal or a 3D video signal is determined, for example, by referencing the 2D/3D identification signal included in “user_data” of the picture layer defined by MPEG-2 Video standard (MPEG4-AVC standard). It is also possible to reference special signal data, added to the last one line of the video signal, to identify that the signal is a 3D video signal.

In S301, the reproduction device determines whether the format detection result in S300 indicates that the received video signal is a 3D video signal. If the received video signal is not a 3D video signal (Case 1), the menu image is multiplexed on the video signal (S302). In the description below, the processing in which the menu image is multiplexed without being adapted to the 3D video display is also called “2D video processing” (processing in which a menu image is assumed to be displayed as a 2D image on the display device, for example, processing in which the menu image is multiplexed directly on the video signal).

If it is determined in S301 that the video signal is a 3D video signal (Yes), the apparatus identification reading 105 acquires information about the connected display device. For example, this processing is the processing for acquiring the EDID information on the connected display device via HDMI (S303).

In S304, the reproduction device determines whether the display device, whose information is acquired in S303, can display a 3D video. If the connected display device is a 2D display device that cannot display a 3D video (Case 2), 2D video processing is performed in S305. In this case, it is also possible to create a video signal, which notifies the user that the display device cannot display a 3D video, and output the created video signal on the display device.

This message may be displayed for several seconds and then erased. Displaying the message in this way is an efficient way to prevent the user from feeling that the message is troublesome. A voice notification may be issued, or a special mark may be displayed on the screen, to notify the situation.

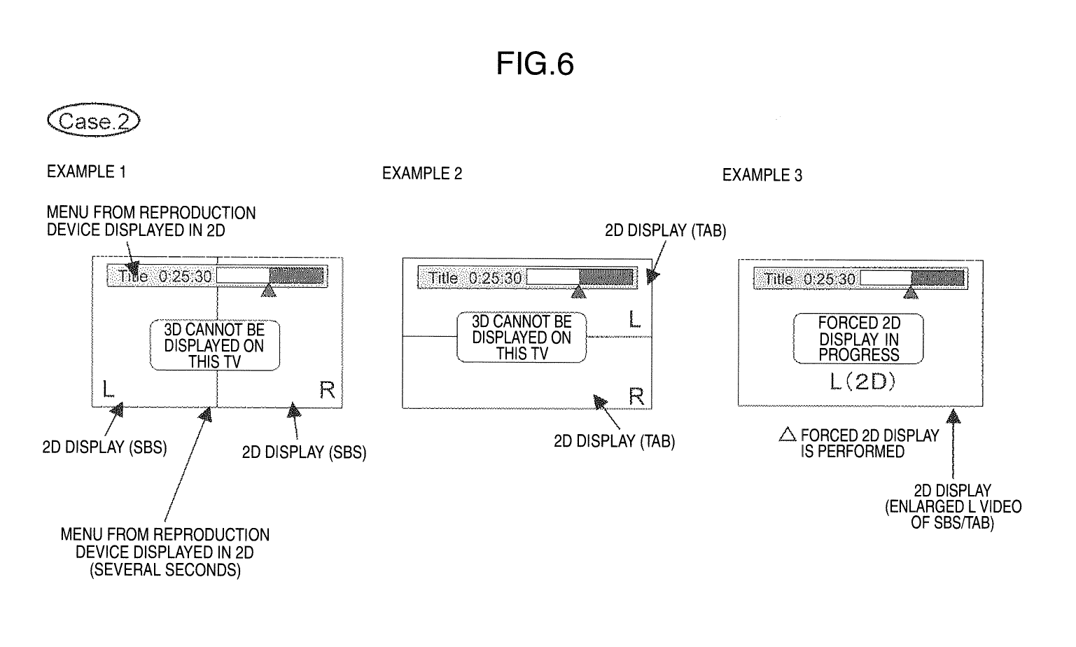

When an SBS format or TAB format 3D video signal is displayed on the display device as a 2D video, the L video and the R video are displayed on one screen, one half of the screen for each video, as shown in example 1 and example 2 in FIG. 6. When the display device cannot display a 3D video, another configuration is also possible in which the received 3D video signal is converted to a 2D video signal (for example, a video signal is generated so that the left-eye video, one-half of the screen in size, is enlarged to the size of one screen, or the left-eye video and the right-eye video are combined to generate a 2D video signal, etc.) and then the converted 2D video signal is output from the reproduction device (S306). In the description below, this processing is called a forced 2D video signal output.

The video reproduction device 100 may also be configured to have a user interface that accepts an input from the user as well as a mechanism to allow the user to define the forced 2D video signal output mode in the memory in the control unit 101. In this configuration, the reproduction device determines in step S306 whether the setting mode is on or off. If the setting mode is off, the 2D video processing in S305 is continued, if the setting mode is on, the menu image is overlaid on the video signal that is converted to a 2D video signal, and the video, such as the one shown in example 3 in FIG. 6, is output by the video signal processing unit 103 (S307).

The configurations described above allow the user to view content in 2D, displayed to the panel size of the display device, even when the content includes a 3D video signal and the display device cannot display a 3D video.

If it is determined in S304 that the display device can display a 3D video, the apparatus control processing 104 acquires, in S308, the information whether the display device is in the 2D setting mode or 3D setting mode.

For example, the apparatus control processing 104 uses the extended function definition of HDMI-CEC to acquire the information. The information about the 3D video signal method that can be processed by the display device, for example, which format, SBS or TAB, the display device uses, is acquired also by the apparatus control processing 104 or the apparatus identification reading unit 105.

In this case, if the TAB-format D video signal display is set for the display device when the video signal is an SBS format 3D video signal, the video cannot be displayed properly as a 3D video. To address this problem, the display setting of the display device may be switched automatically to the SBS format via the apparatus control processing 104 or the switching prompt message may be presented to the user. When the display setting is switched automatically, the message indicating that the format is switched may be displayed to the user.

It is also possible to convert an SBS-format 3D video signal, which will be output from the reproduction device, to a TAB-format 3D video signal and then output to the display device.

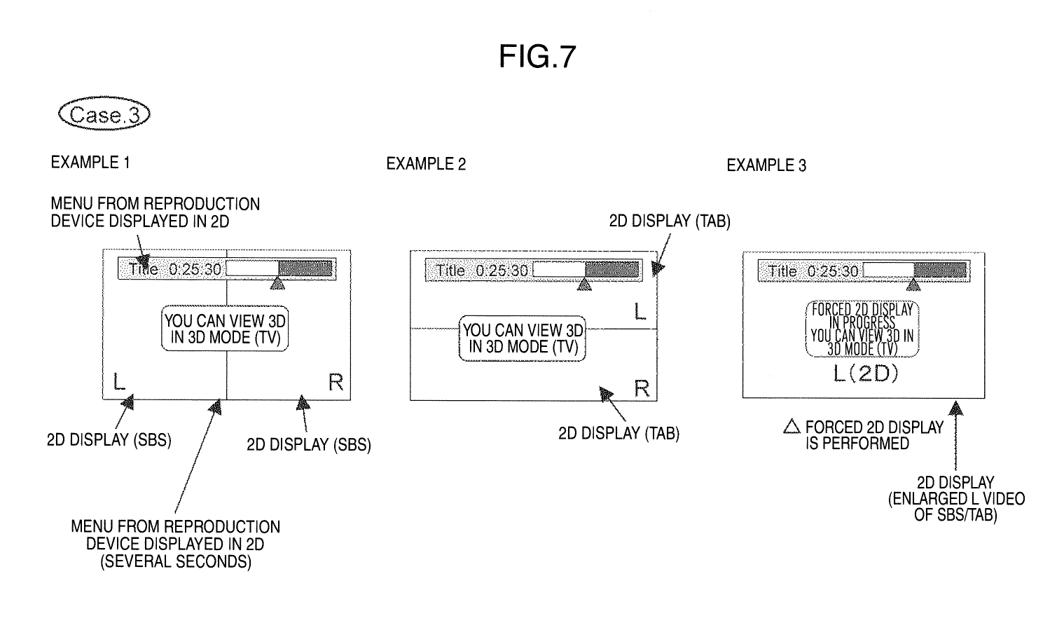

In step S308, the reproduction device determines if the display device is in the 3D setting mode. If the display device is in the 2D setting mode (Case 3), the 2D video processing is performed in S309. At this time, the reproduction device creates a video signal notifying to the user that the video signal can be displayed as a 3D video and outputs the created video signal to the display device (example 1 and example 2 in FIG. 7).

In this case, because the user specifies 2D display for the display device that can display a 3D video, it is also possible to perform forced 2D video signal output so that the user can view the video comfortably in 2D (S310) (example 3 in FIG. 7).

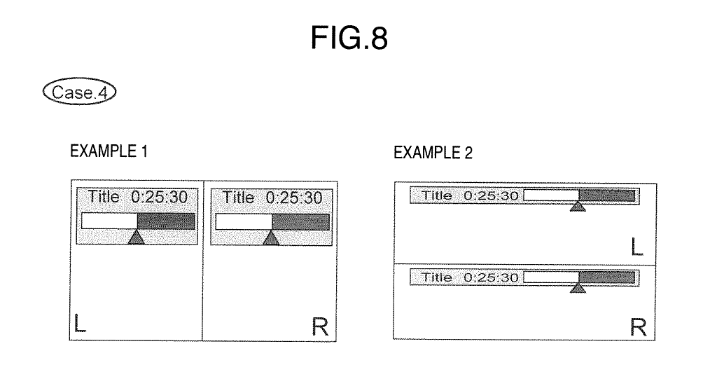

If the display device is in the 3D setting mode in S308 (Case 4), the two menu images, one with the size of the L video and the other with the size of the R video, are created when the video signal is an SBS format video signal. The created menu images are then overlaid on the L video and the R video respectively (S311) (example 1 and example 2 in FIG. 8). The processing, in which the menu images are multiplexed on video signals assuming that that the video will be displayed in 3D as described above, is also called “menu image 3D conversion processing”.

This processing allows the L video and the R video to be separated and enlarged and then sent to the left eye and the right eye on the display device side respectively, making it possible to display the menu image properly even when a 3D image is displayed.

If the depth information (depth map) created from the L video and the R video is available, a parallax corresponding to the depth map may be added to the menu image to be overlaid on each of the L video and the R video for displaying the menu as a 3D image.

For example, with the L-side menu adjusted to the intermediate depth on the depth map, the R-side menu is overlaid by shifting horizontally in such a way that the R-side menu is slightly before the L-side menu. This produces a video as if the menu was floating in the 3D space.

Although the information read by the apparatus identification reading 105 in S303 and S304 and the information acquired by the apparatus control processing 104 in S308 are used in the above description, the method for acquiring information from the display device is not limited to the method described above. For example, in any of steps S303, S304, and S308, the information acquired by the apparatus control processing 104 may be used. Similarly, in any of steps S303, S304, and S308, the information read by apparatus identification reading 105 may be used. It is also possible to use the information about the display device acquired by another method that does not use the apparatus control processing 104 and apparatus identification reading 105.

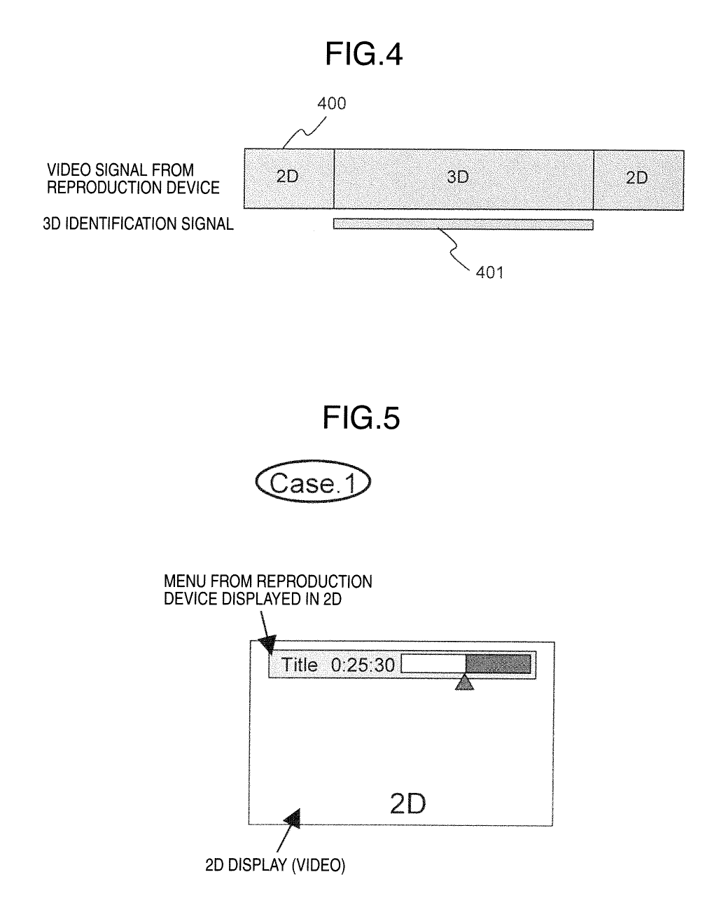

FIG. 4 is a diagram showing an example of video format detection processing performed by the video reproduction device.

The numeral 400 indicates a reproduced video signal that includes a 3D identification signal 401 identifying that the video is a 3D video. For example, the 2D/3D identification signal is included in “user_data” of the picture layer defined by MPEG-2 Video standard (MPEG4-AVC standard).

The video signal generation unit 102 references the 3D identification signal 401, included in a video signal, to determine whether the video signal being reproduced is a 2D signal or a 3D signal. When the 3D identification signal is not added, a processing unit such as the video signal processing 103 may be used to analyze the video to automatically detect an SBS format 3D video signal or a TAB format 3D video signal.

For example, when an SBS format 3D video signal is separated at the center, the left-half video and the right-half video are similar. Therefore, the investigation of the arrangement or distribution of brightness in the left half and right half in the line memory or the calculation of matching degree between the left-half image and the right-half image through the block matching method indicates that the difference between the video characteristics of the left-half video and those of the right-half video is within a predetermined threshold range, the signal is identified as an SBS format 3D video signal.

FIG. 5 is a diagram showing an example of a video signal that is output from the video reproduction device in “Case 1” in FIG. 3.

This is the case in which a video signal is determined as a 2D video signal in S301 in FIG. 3 (Case 1). In this case, because the video signal is 2D, the video reproduction device 100 outputs a video created by overlaying the menu image on the 2D video signal. As a result, the video and the menu screen, created by the video reproduction device, are sent to the display device as a video such as that shown in FIG. 5.

FIG. 6 is a diagram showing an example of a video signal that is output from the video reproduction device in “Case 2” in FIG. 3.

This is the case in which the information acquired by the apparatus identification information 108 in the display device indicates, in S304 in FIG. 3, that the display device cannot display a 3D video (Case 2). In this case, because the display device cannot display a 3D video, the video reproduction device 100 outputs a video signal created by overlaying the menu image directly on the SBS format 3D video (example 1) or the TAB format 3D video signal (example 2).

The above processing transmits the video signal, shown in FIG. 6, to the display device. In this case, it is also possible to display a message indicating that the display device, connected to the user, cannot display a 3D video.

Because the user does not always want to directly view the SBS format video or TAB format video that is divided in two halves, the message gives the user the information as to why the video is displayed in this manner.

If the setting is specified in S306 indicating that the SBS format 3D video signal or the TAB format 3D video signal is converted to a 2D signal before being output, the video similar to that in Case 1 in FIG. 5 is output, for example, by selecting and enlarging the left eye video L. In this case, the information may be displayed to the user to notify that the 3D video signal is converted to a 2D video signal. This information allows the user to recognize that the content being viewed includes a 3D video signal.

These messages are displayed in various ways. For example, the messages are displayed for several seconds and then erased in several seconds to prevent the user from feeling that the message is troublesome, the messages are displayed for a predetermined time to repeatedly give the user the information, or the messages are displayed or not displayed according to the user operation.

FIG. 7 is a diagram showing an example of a video signal that is output from the video reproduction device in “Case 3” in FIG. 3.

This is the case in which the information acquired by the apparatus identification information 108 in the display device indicates, in S304 in FIG. 3, that the display device can display a 3D video but 3D setting is not specified (Case 3). In this case, though the display device can display a 3D video, the user does not select 3D setting.

The display processing, including forced 2D video signal output, is similar to that in FIG. 6. The message gives the user the information indicating that a 3D video can be displayed by placing the display device in the 3D setting mode, thus prompting the user to place the display device in the 3D setting mode.

FIG. 8 is a diagram showing an example of a video signal that is output from the video reproduction device in “Case 4” in FIG. 3.

This is the case in which the information acquired by the apparatus control processing 104 indicates, in S308 in FIG. 3, that the display device is in the 3D setting mode (Case 4). In this case, the video reproduction device 100 creates two menus, one for the L video and the other for the R video, overlays the created menus on the L video and the R video respectively, creates the SBS format video signal (example 1) or the TAB format video signal (example 2), and outputs the video signal.

This processing can present the menu age to the user properly even when a 3D video is displayed on the display device.

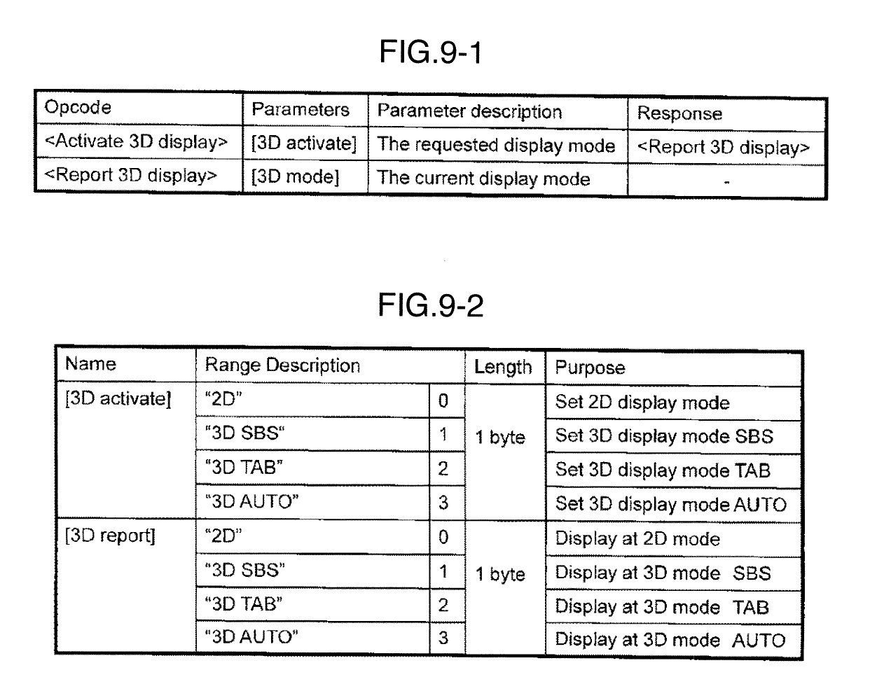

FIG. 9 is a diagram showing the control messages used for the cooperation between the video reproduction device and the display device.

FIG. 9-1 shows an example of definition of the messages that are newly added to GEC, and FIG. 9-2 shows an example of definition of the parameters for the messages. There are the two types of codes: activate code used to request the display device to change the display setting and the report code used to inquire about the current display setting state.

Each control code can identify the SBS format and the TAB format. An image, such as a menu, can be combined with a video according to the identified format.

“Auto” indicates the frame packing method (method in which the left-eye video stream and the right-eye video stream are included in the video signal). In this case, an image such as a menu is combined with the left-eye video stream and the right-eye video stream respectively.

The report code is used to identify the current display setting of the display device and, based on the identified display setting, the method for combining an image, such as a menu, with a video can be selected. The activate code may be used to change the display setting of the display device to the method of a 3D video signal output by the video reproduction device. This ability allows a menu image to be presented to the user properly.

According to this embodiment, the video reproduction device 100 can determine whether the connected display device 106 can display a 3D video and whether the connected display device is set in the 3D mode and, based on the performance or the current setting of the connected display device, overlay an image such as a menu on a video signal, thus making it possible to display the menu image properly.

Although an example in which a menu image is overlaid on a video signal is described in this embodiment, the present invention is applicable to the processing in which an image, other than a menu, is overlaid on a video signal. For example, an electronic program guide or a list of recorded programs created by the reproduction device, when overlaid on a video signal, can be displayed properly.

When a video, such as a menu, an electronic program guide, or a list of recorded programs generated by the reproduction device, is output, it is also possible to control the display device not to be placed in the 3D mode via the apparatus control processing 104. This control eliminates the need for compressing an image, such as a menu, to one half according to the SBS format or TAB format 3D video signal, prevents text information, such as a menu, from becoming too small to read, and displays the menu properly.

This embodiment is applicable to both a display device on ich 3D glasses are required and a display device on which 3D glasses are not required.

Programs operating on the video reproduction device and the display device may be installed in the device, stored in a recording medium, or downloaded via a network. Placing no restriction on the program distribution method in this way allows the programs to be provided in a variety of usage modes, resulting in an increased number of users.

Although the reproduction device and the display device are connected via an HDMI cable in the example in this embodiment, the connection between the reproduction device and the display device is not limited to this configuration. For example, the present invention is applicable also to the connection between the reproduction device and the display device via an Internet line, a WAN (Wide Area Network), a LAN (Local Area Network), or a DLNA (Digital Living Network Alliance) line. For example, when a menu image created on the server side is overlaid on a video signal to be sent to a client side in VOD (Video On Demand) or other applications, the menu can be overlaid on the video signal according to the performance or the setting of the display device on the client side.

### REFERENCE SIGNS LIST

100 Video reproduction device
101 Control unit
102 video signal generation unit
103 Video signal processing unit
104 Apparatus control processing unit
105 Apparatus identification reading unit
106 Display device
107 Apparatus control processing unit
108 Apparatus identification information unit
109 Control unit
110 Video processing unit
200 Reproduction device video signal
201 Example of 2D video signal output
202 Example of 3D video signal output
203,204 Example of 3D display on display device when 202 is displayed
400 Reproduction device video signal
401 3D identification signal

1. A reproduction device that outputs a video signal to a connected display device, the reproduction device comprising:
a reproduction unit that reproduces a video signal;
an image information generation unit that generates image information to be superimposed on the video signal reproduced by said reproduction unit;
a superimposition unit that superimposes the image information on the video signal, the video signal reproduced by said reproduction unit, the image information generated by said image information generation unit;
an output unit that outputs the video signal on which the image information is superimposed by said superimposition unit;
a reading unit that reads information about the display device from the connected display device; and
a control processing unit that acquires information about a state of the display device from the connected display device wherein
said superimposition unit changes a method for superimposing the image information on the video signal based on the information about the display device read by said reading unit and on the information about the state of the display device acquired by said control processing unit.

2. The reproduction device according to claim 1 wherein
the information about the display device read by said reading unit includes information indicating whether or not the display device can display a 3D video.

3. The reproduction device according to claim 1 wherein
the information about the state of the display device acquired by said control processing unit includes information indicating whether or not 3D video display setting is specified for the display device.

4. The reproduction device according to claim 1 wherein
if the video signal includes a left-eye video and a right-eye video, the information about the display device, read by said reading unit, indicates that the display device can display a 3D video, and the information about the state of the display device, acquired by said control processing unit, indicates that the display device is in a state in which a 3D video is displayed,
said superimposition unit superimposes the image information on each of the left-eye video and the right-eye video of the video signal.

5. A reproduction method that outputs a video signal, reproduced by a reproduction device, to a display device, the reproduction method comprising the steps of:
reproducing a video signal;
generating image information to be superimposed on the reproduced video signal;
superimposing the generated image information on the reproduced video signal;
outputting the video signal on which the image information is superimposed;
reading information about the display device from the display device; and
acquiring information about a state of the display device from the display device wherein
a method for superimposing the image information on the video signal is changed based on the information about the display device that is read and on the information about the state of the display device that is acquired.

6. The reproduction method according to claim 5 wherein
the information about the display device includes information indicating whether or not the display device can display a 3D video.

7. The reproduction method according to claim 5 wherein
the information about the state of the display device includes information indicating whether or not 3D video display setting is specified for the display device.

8. The reproduction method according to claim 5 wherein
if the video signal includes a left-eye video and a right-eye video, the information about the display device indicates that the display device can display a 3D video, and the information about the state of the display device indicates that the display device is in a state in which a 3D video is displayed,
the image information is superimposed on each of the left-eye video and the right-eye video of the video signal.
